(19) United States
(12) Patent Application Publication
(10) Pub. No.: US 2014/0205116 A1
(43) Pub. Date: Jul. 24, 2014

(54) SYSTEM, DEVICE, AND METHOD FOR ESTABLISHING A MICROPHONE ARRAY USING COMPUTING DEVICES

(71) Applicants: Charles C. Smith, Portland, OR (US); Michelle X. Gong, Sunnyvale, CA (US); Jennifer A. Healey, San Jose, CA (US)

(72) Inventors: Charles C. Smith, Portland, OR (US); Michelle X. Gong, Sunnyvale, CA (US); Jennifer A. Healey, San Jose, CA (US)

(21) Appl. No.: 13/997,696

(22) PCT Filed: Mar. 31, 2012
(86) PCT No.: PCT/US12/31745

§ 371 Date: Oct. 10, 2013

(51) Int. Cl. H04R 3/00

(52) U.S. Cl. CPC H04R 3/005
USPC 381/122

(57) ABSTRACT

A system, device, and method for generating an audio output includes a master computing device and a plurality of client computing devices. Each client computing device includes a microphone to record audio signals. The client computing devices generate audio data based on the audio signals and transmit the audio data to the master computing device. The master computing device generates a final, higher quality audio output as a function of the audio data received from collection of participating the client computing devices.

### BACKGROUND

During meetings, conferences, and other gatherings, it is often desirable to record speakers and participants to ensure everyone present at the event can properly hear the speaker and, in some cases, to establish an audio transcript of the event. In many such meetings or conferences, a single microphone is used to capture all public speakers. For example, in many business meetings, a single conference telephone is placed in a central location, such as in the center of a conference table, to record all participants of the meeting. However, even though the recording device is located in a central location, speakers farther away from the recording device may not be recorded properly or at the same quality as speakers closer to the recording device. Similarly, during conferences or lectures, the recording device may capture only the principle speaker (e.g., the professor, lecturer, or guest speaker) but fail to capture any participants from the audience or those otherwise farther away from the microphone or other recording device.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of at least one embodiment of a system for generating an audio output;

FIG. 2 is a simplified block diagram of at least one embodiment of a client computing device of the system of FIG. 1;

FIG. 3 is a simplified block diagram of at least one embodiment of an environment of the client computing device of FIG. 2;

FIG. 4 is a simplified block diagram of at least one embodiment of an environment of a master computing device of FIG. 1;

FIG. 5 is a simplified flow diagram of at least one embodiment of a method for generating an audio output that may be executed by the client computing devices of FIGS. 1 and 3; and

FIGS. 6 & 7 are a simplified flow diagram of at least one embodiment of a method for generating a final audio output that may be executed by the master computing device of FIGS. 1 and 4.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions carried by or stored on a transitory or non-transitory machine-readable medium, which may be read and executed by one or more processors. A machine-readable medium may be embodied as any device, mechanism, or physical structure for storing or transmitting information in a form readable by a machine (e.g., a computing device). For example, a machine-readable medium may be embodied as read only memory (ROM); random access memory (RAM); magnetic disk storage media; optical storage media; flash memory devices; mini- or micro-SD cards, memory sticks, electrical signals, and others.

In the drawings, specific arrangements or orderings of schematic elements; such as those representing devices, modules, instruction blocks and data elements, may be shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

In general, schematic elements used to represent instruction blocks may be implemented using any suitable form of machine-readable instruction, such as software or firmware applications, programs, functions, modules, routines, processes, procedures, plug-ins, applets, widgets, code fragments and/or others, and that each such instruction may be implemented using any suitable programming language, library, application programming interface (API), and/or other software development tools. For example, some embodiments may be implemented using Java, C++, and/or other programming languages. Similarly, schematic elements used to represent data or information may be implemented using any suitable electronic arrangement or structure, such as a register, data store, table, record, array, index, hash, map, tree, list, graph, file (of any file type), folder, directory, database, and/or others.

Further, in the drawings, where connecting elements, such as solid or dashed lines or arrows, are used to illustrate a connection, relationship or association between or among two or more other schematic elements, the absence of any such connecting elements is not meant to imply that no connection, relationship or association can exist. In other words, some connections, relationships or associations between elements may not be shown in the drawings so as not to obscure the disclosure. In addition, for ease of illustration, a single connecting element may be used to represent multiple connections, relationships or associations between elements. For example, where a connecting element represents a communication of signals, data or instructions, it should be understood by those skilled in the art that such element may represent one or multiple signal paths (e.g., a bus), as may be needed, to effect the communication.

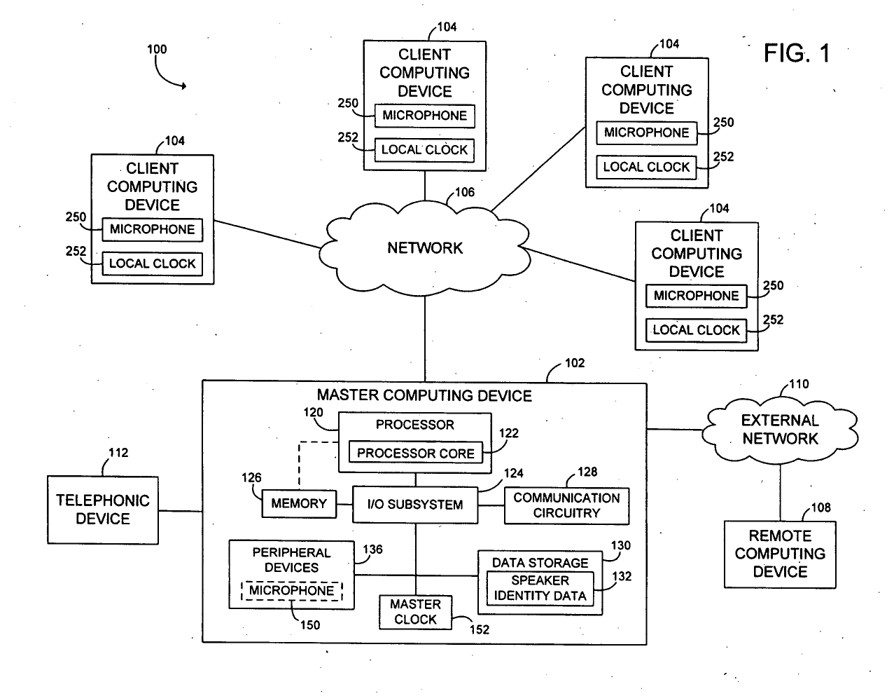

Referring now to FIG. 1, a system 100 for generating a final audio output of a meeting, presentation, gathering, or other event includes a master computing device 102 and one or more client computing devices 104, which communicate with each other over a point-to-point or ad-hoc network 106. The system 100 may be implemented in any location or at any event in which multiple speakers may participate. For example, the system 100 may be established during a business meeting, a lecture, speaking event, or other event having multiple speakers.

Each of the client computing devices 104 may be embodied as any type of mobile computing device such as a smartphone, tablet computer, laptop, small factor computer, personal digital assistant, or other mobile computing device. In some embodiments, the client computing devices 104 may be embodied as personal mobile computing devices owned or otherwise controlled by an associated user, who may be a participant in the meeting, an audience member of a lecture or presentation, or fellow speaker at the event. For example, the client computing devices 104 may be embodied as a personally owned smartphone or tablet computer brought to the event by each user. Each of the client computing devices 104 includes a local microphone 250 configured to receive local audio signals, such as the speech of the associated user. The client computing devices 104 transmit the captured audio data to the master computing device 102 over the network 106. The master computing device 102 generates a final audio output as a function of the audio data received from each of the client computing devices 104.

It should be appreciated that because the local microphone 250 of each client computing device 104 is located near the associated user, the audio output generated by each client computing device 104 may be of a higher quality for the speech of that particular user, or nearby speaker, relative to an audio of that user captured using a single microphone (e.g., a single, centrally located microphone). As such, the final audio output generated by the master computing device 102 may have an improved overall signal-to-noise ratio, or otherwise quality, for all speakers, even though such speakers may be spaced apart from each other or distributed about the event space.

The master computing device 102 may be embodied as any type of computing device capable of performing the functions described herein. In some embodiments, the master computing device 102 may be similar to the client computing devices 104 but elected as the “master” device via a master-establishment procedure as discussed in more detail below. In such embodiments, the master computing device 102 may be embodied as, for example, a mobile computing device such as a smartphone, tablet computer, laptop, small factor computer, personal digital assistant, or other mobile computing device. In other embodiments, the master computing device 102 may be embodied as a conference recording device, conference telephonic device, desktop computer, or other computing device.

As shown in FIG. 1, the illustrative master computing device 102 includes a processor 120, an I/O subsystem 124, a memory 126, communication circuitry 128, data storage 130, one or more peripheral devices 138; and a master clock 152. In some embodiments, several of the foregoing components may be incorporated on a motherboard of the master computing device 102, while other components may be communicatively coupled to the motherboard via, for example, a peripheral port. Furthermore, it should be appreciated that the master computing device 102 may include other components, sub-components, and devices commonly found in a mobile computing device, teleconference recording device, telephonic device, and/or other computer device, which are not illustrated in FIG. 1 for clarity of the description.

The processor 120 of the master computing device 102 may be embodied as any type of processor capable of executing software/firmware, such as a microprocessor, digital signal processor, microcontroller, or the like. The processor 120 is illustratively embodied as a single core processor having a processor core 122. However, in other embodiments, the processor 120 may be embodied as a multi-core processor having multiple processor cores 122. Additionally, the master computing device 102 may include additional processors 120 having one or more processor cores 122 in other embodiments.

The I/O subsystem 124 of the master computing device 102 may be embodied as circuitry and/or components to facilitate input/output operations with the processor 120 and/or other components of the master computing device 102. In some embodiments, the I/O subsystem 124 may be embodied as, or otherwise include, a memory controller hub (MCH or “northbridge”), an input/output controller hub (ICH or “southbridge”), and a firmware device. In such embodiments, the firmware device of the I/O subsystem 124 may be embodied as a memory device for storing Basic Input/Output System (BIOS) data and/or instructions and/or other information (e.g., a BIOS driver used during booting of the master computing device 102). However, in other embodiments, I/O subsystems having other configurations may be used. For example, in some embodiments, the I/O subsystem 124 may be embodied as a platform controller hub (PCH). In such embodiments, a memory controller hub (MCH) may be incorporated in or otherwise associated with the processor 120, and the processor 120 may communicate directly with the memory 126 (as shown by the hashed line in FIG. 1). Additionally, in other embodiments, the I/O subsystem 124 may form a portion of a system-on-a-chip (SoC) and be incorporated, along with the processor 120 and other components of the master computing device 102, on a single integrated circuit chip. As such, it should be appreciated that each component of the I/O subsystem 126, as well as other components of the master computing device 102, may be located on a common integrated circuit chip in some embodiments.

The processor 120 is communicatively coupled to the I/O subsystem 124 via a number of signal paths. Those signal paths (and other signal paths illustrated in FIG. 1) may be embodied as any type of signal paths capable of facilitating communication between the components of the master computing device 102. For example, the signal paths may be embodied as any number of wires, cables, light guides, printed circuit board traces, via, bus, intervening devices, point-to-point connections, and/or the like.

The memory 126 of the master computing device 102 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 126 is communicatively coupled to the I/O subsystem 124 via a number of signal paths. Although only a single memory device 126 is illustrated in FIG. 1, the master computing device 102 may include additional memory devices in other embodiments. Various data and software may be stored in the memory device 126. For example, one or more operating systems, applications, programs, libraries, and drivers that make up the software stack executed by the processor 120 may reside in memory 126 during execution.

The communication circuitry 128 of the master computing device 102 may include any number of devices and circuitry for enabling communications between the master computing device 102 and the client computing devices 104, as well as other devices of the system 100 as discussed in more detail below. The communication circuitry 128 may use any suitable communication protocol to directly communicate with the client computing devices 104 such as, for example, Bluetooth®, Wi-Fi® (i.e., the IEEE 802.11 standard), and/or other communication protocols or standards. In the illustrative embodiment of FIG. 1, the network 106 is an ad-hoc network formed between the master computing device 102 and the client computing devices 104. As such, the communication circuitry 128 of the illustrative master computing device 102 is configured to communicate with the client computing devices 104 using a point-to-point communication protocol such as, for example, Wi-Fi® Direct.

Additionally, the communication circuitry 128 may include devices and circuitry for enabling communication with other devices of the system 100. For example, in some embodiments, the system 100 may include one or more remote computing devices 108 with which the master computing device 102 may communicate over an external network 110 to transmit, for example, the final audio output. The external network 110 may be embodied as any number of various wired and/or wireless data and/or voice communication networks. For example, the external network 110 may be embodied as or otherwise include a local area network (LAN), a wide area network (WAN), or a publicly-accessible, global network such as the Internet. The master computing device 102 may use any suitable communication protocol to communicate with the remote computing device 108 over the external network 110 depending on, for example, the particular type of network(s) 110.

The data storage 130 may be embodied as any type of device or devices configured for the short-term and/or long-term storage of data such as, for example, memory devices and circuits, memory cards, hard disk drives, solid-state drives, or other data storage devices. In some embodiments, the master computing device 102 may maintain a speaker identity database 132 with which the master computing device 102 may identify a speaker from the audio data received from each of the client computing devices 104. For example, in some embodiments, the master computing device 102 may store client identifications (IDs), associated usernames, and/or voiceprints received from each of the client computing devices 104. Such speaker identity data may be used by the master computing device 102 to identify a speaker and “tag” or otherwise associate identification data, such as a username, with the relevant portion of the audio data as discussed in more detail below.

The peripheral devices 138 of the master computing device 102 may include any number of additional input/output devices, interface devices, and/or other peripheral devices. For example, the peripheral devices 138 may include a display, a keyboard or other data input device, external speakers, and/or other peripheral devices. In some embodiments, the master computing device 102 may include a local microphone 150 to record local audio signals such as the speech of a user of the master computing device 102.

As discussed above, the master computing device 102 also includes a master clock 152. In some embodiments, the master clock 152 is embodied as a standard system clock′ of the master computing device 102. However, in other embodiments, the master clock 152 is embodied as a specialized clock. The master computing device 102 utilizes the master clock 152, and local clocks 252 of the client computing devices 104, to establish a shared master clock between the devices 102, 104. By establishing the shared master clock, as discussed in more detail below, the master computing device 102 is able to synchronize properly the audio data received from each of the client computing devices 104.

In some embodiments, the system 100 may also include a telephonic device 112. The telephonic device 112 may be, for example, a conference telephone, a conference telephonic recording device, or other telephonic device capable of connecting the master computing device 102 to a private branch exchange (PBX) or to the general telephone system. In this way, the master computing device 102 may receive calls from outside the meeting or conference via the telephonic device 112 as is typical in telephonic conference calls.

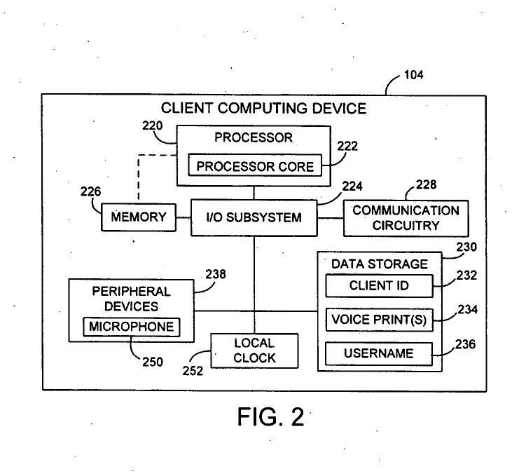

Referring now to FIG. 2, as discussed above, the client computing devices 104 may be embodied as any type of mobile computing device such as a smartphone, tablet computer, laptop, small factor computer, personal digital assistant, or other mobile computing device. The illustrative client computing device 104 of FIG. 2 includes a processor 220, an I/O subsystem 224, a memory 226, communication circuitry 228, data storage 230, one or more peripheral devices 238, and a local clock 252. In some embodiments, several of the foregoing components may be incorporated on a motherboard of the client computing device 104, while other components may be communicatively coupled to the motherboard via, for example, a peripheral port. Furthermore, it should be appreciated that the client computing device 104 may include other components, sub-components, and devices commonly found in a mobile computing device, which are not illustrated in FIG. 2 for clarity of the description.

Each of the processor 220, I/O subsystem 224, and memory 226 may be similar to the processor 120, I/O subsystem 124, and memory 126 of the master computing device 102 described above. As such, the description of those components applies equally to the similar components of the illustrative client computing device 104 and is not repeated herein for clarity of the present description.

The communication circuitry 228 of the client computing device 104 may include any number of devices and circuitry for enabling communications between the client computing device 104 and the master computing device 102 over the network 106. As discussed above, the network 106 is illustratively embodied as an ad-hoc network. As such, the communication circuitry 228 of the client computing device 104 may be configured to communicate with the master computing device 102 using a point-to-point communication protocol such as, for example, Wi-Fi® Direct.

The data storage 230 may be embodied as any type of device or devices configured for the short-term and/or long-term storage of data such as, for example, memory devices and circuits, memory cards, hard disk drives, solid-state drives, or other data storage devices. In some embodiments, each client computing device 104 may maintain, or otherwise store, a client identification (ID) 232, one or more voice prints 234, and a username 236. The client ID 232 uniquely identifies the client computing device 104 from other client computing devices 104 and may be embodied as a media access control (MAC) address, a globally unique identifier (GUID), or other identifier capable of differentiating the client computing devices 104. The voice print 234 may be embodied as a voice sample of the user of the corresponding client computing device 104. The voice print 234 allows a computing device (e.g., the master computing device 102 or a client computing device 104) to identify an unknown speaker within a piece of audio data by comparing the voice print 234 to the audio data. In some embodiments, the voice print 234 may be a random sampling of the user's speech or may be embodied as a predetermined, common text that is spoken by the user. Additionally, in some embodiments as discussed in more detail below, each client computing device 104 may store additional voiceprints 234 of other users from which the corresponding client computing device 104 may attempt to identify a speaker within an audio sample. The username 236 is associated with the client ID 232 and/or the voice print 234 to provide a textual name of the user of the corresponding client computing device 104 and/or the speaker of an associated voice print 234.

The peripheral devices 238 of the client computing devices 104 may include any number of additional input/output devices, interface devices, and/or other peripheral devices. For example, the peripheral devices 238 may include a display, a keyboard or other data input device, external speakers, and/or other peripheral devices. In the illustrative embodiment, each client computing device 104 includes a local microphone 250 to record local audio signals such as the speech of a user of the client computing device 104. The local microphone 250 may be incorporated into the client computing device 104 or otherwise connected thereto.

As discussed above, each client computing device 104 also includes a local clock 252. The local clock 252 is used by each client computing device 104 to establish a shared master clock with the master computing device 102. In some embodiments, the master computing device 102 may transmit a beacon time stamped with the master clock 152 to each of the client computing devices 104. In such embodiments, each client computing device 104 may determine a local time offset based on the master clock 152 and the local clock 252. In other embodiments, each client computing device 104 may transmit a beacon that is time-stamped using the local clock 242 to the master computing device 102, which in turn determines a time offset for each corresponding client computing device 104 based on the time-stamped beacon and the master clock 152.

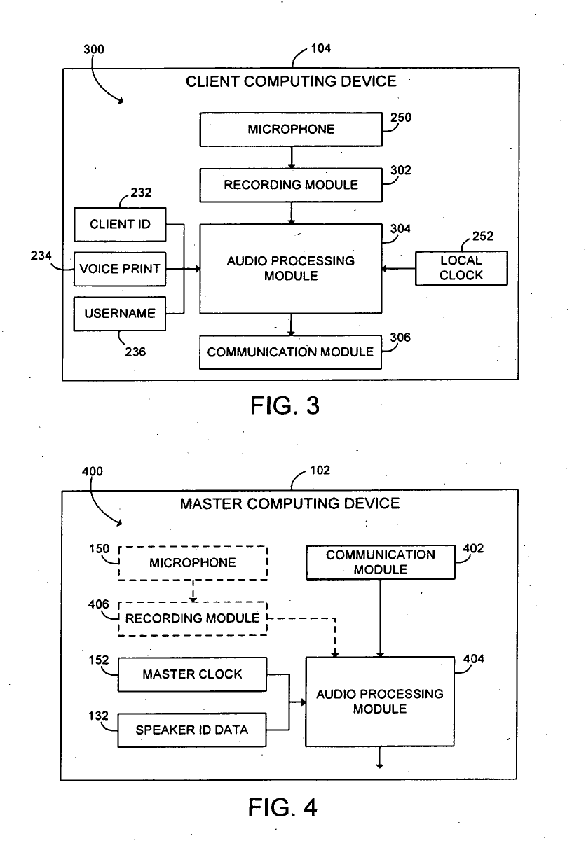

Referring now to FIG. 3, in use, each client computing devices 104 may establish an environment 300 for recording, processing, and communicating audio data. The environment 300 includes a recording module 302, an audio processing module 304, and a communication module 306. Each of the modules 302, 304, 306 may be embodied as software, firmware, hardware, or a combination of software, firmware, and/or hardware components. Additionally, in other embodiments, the environment 300 of each client computing device 104 may include additional, fewer, or alternative modules.

The recording module 302 is configured to receive audio signals generated by the local microphone 250 of the client computing device 104 and provide such signals to the audio processing module 304. In some embodiments, the recording module 302 may additionally perform some amount of pre-processing on the audio signals generated by the local microphone 250.

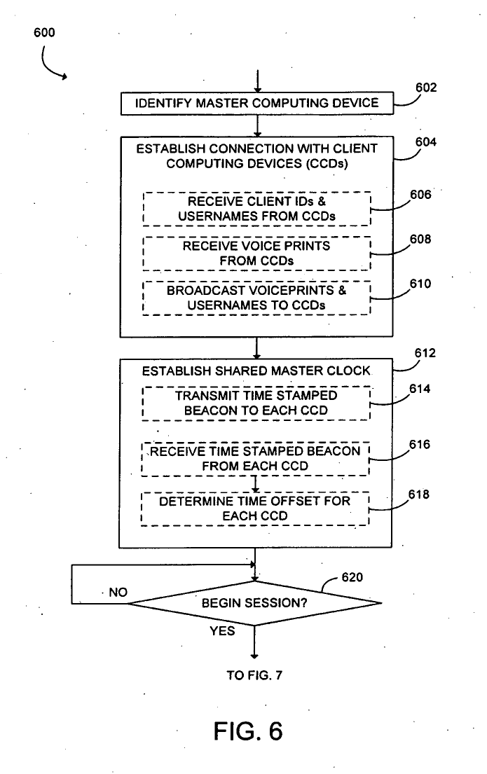

The audio processing module 304 processes the audio signals received from the recording module 302 and generates packetized audio data based thereon. As discussed in more detail below with regard to FIG. 5, the audio processing module 304 may stamp each audio data packet with the local clock 252 or a shared master clock previously established with the master computing device 102. Additionally, in some embodiments, the audio processing module 304 may attach or otherwise associate the corresponding client ID 232 and/or username 236 to each packetized audio data transmitted to the master computing device 102 (e.g., within the metadata of the packet). Further, in some embodiments, the audio processing module 304 may be configured to identify a speaker recorded in the audio signals by comparing audio samples to the voice print(s) 234. If a match of the voice print(s) 234 is determined, the audio processing module 304 may associate the username corresponding to the matching voice print 234 to the packetized audio data.

The communication module 306 is configured to transmit the packetized audio data generated by the audio processing module 304 to the master computing device 102. As discussed above, the communication module 306 may use any suitable communication protocol to transmit the packetized audio data to the master computing device 102. In the illustrative embodiment, the network 106 is embodied as an ad-hoc, point-to-point network, and the communication module 306 may use a suitable point-to-point communication protocol such as, for example, Wi-Fi® Direct.

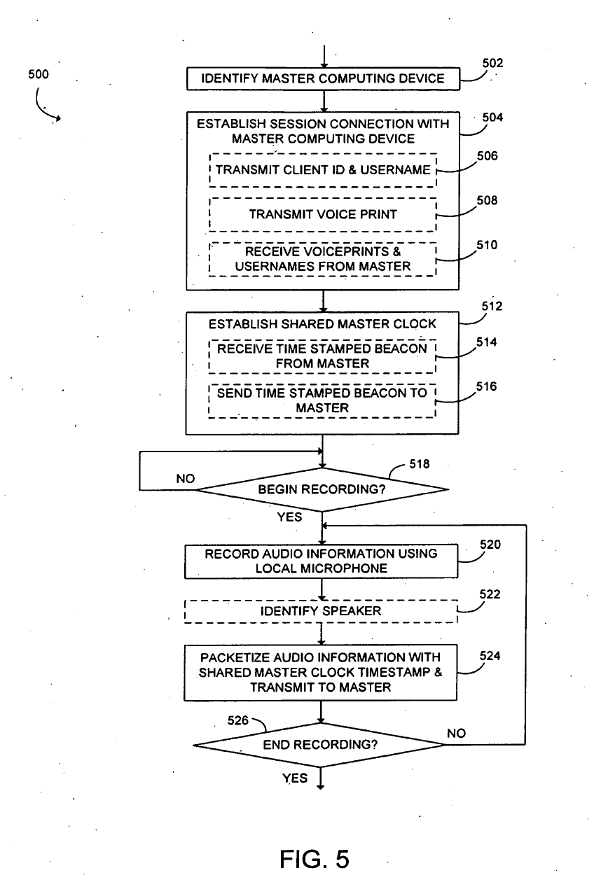

Referring now to FIG. 4, similar to the client computing devices 104, the master computing device 102 may establish an environment 400 during operation. The environment 400 includes a communication module 402 and an audio processing module 404. Additionally, in embodiments wherein the master computing device 102 includes a local microphone 150, the environment 400 may further include a recording module 406, similar to the recording module 302 of the client computing devices 104. Each of the modules 402, 404, 406 may be embodied as software, firmware, hardware, or a combination of software, firmware, and/or hardware components. Additionally, in other embodiments, the environment 400 of the master computing device 102 may include additional, fewer, or alternative modules.

The communication module 402 is configured to communicate with the client computing devices 104 and receive the packetized audio data transmitted by each client computing device 104. Similar to the communication module 306 of the client computing devices 104, the communication module 402 may use any suitable communication protocol to communicate with the client computing devices 104 such as, for example, a point-to-multi-point communication protocol (e.g. Wi-Fi® Direct).

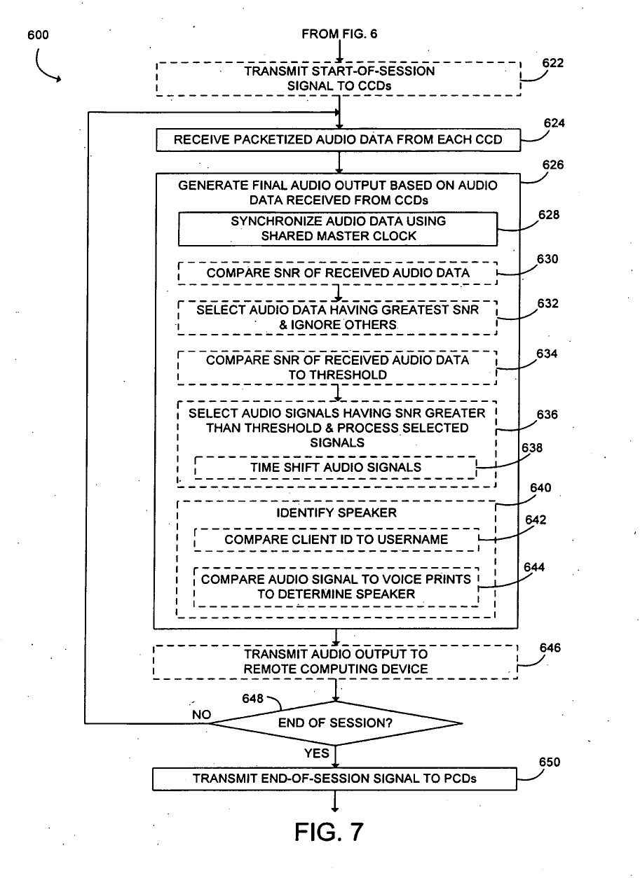

The audio processing module 404 receives the packetized audio data from each of the client computing devices 104 from the communication module 403 and generates a final audio output based thereon. As discussed in more detail below with regard to FIGS. 6 and 7, the audio processing module 404 may generate the final audio data by selecting the corresponding audio signal having the highest signal-to-noise ratio or by mixing those audio signals having a signal-to-noise ratio greater than a reference threshold value.

The audio processing module 404 may synchronize each of the audio data packets using the master clock 152 and the shared master clock established with the client computing devices 104. As discussed in more detail below, the master computing device 102 may transmit a beacon time stamped with the master clock 152 to each of the client computing devices 104, which may generate a local time offset. Alternatively, the master clock 152 may receive a time-stamped beacon from each of the client computing devices 104 and generate a corresponding time offset for each client computing device 104. Of course, in other embodiments, other synchronization methodologies and technologies may be used to synchronize the master computing device 102 and the client computing devices 104. For example, in some embodiments the master computing device 102 and the client computing devices 104 may implement a synchronization methodology according to the Institute of Electrical and Electronic Engineers (IEEE) standard 802.1AS or other timing and synchronization standard.

Additionally, in some embodiments, the audio processing module 404 may be configured to identify a speaker recorded in the audio signal of each audio data received from the client computing devices 104. To do so, the master computing device 102 may compare the audio signals from each client computing device 104 (or just the selected audio signal) to one or more voice prints included in the speaker ID data 132. Upon determining a match, the master computing device may associate a corresponding username or client ID with the audio signal to provide a form of identification of the speaker. The final audio output generated by the audio processing module 404 may be stored in the master computing device 102 for later review and/or transmitted to the remote computing device 108, which may be participating in the meeting or conference or may simply provide a remote storage. Additionally, in embodiments wherein the system includes the telephonic device 112, the master computing device 102 may transmit the final audio output to the telephonic device 112 to facilitate the participation of additional remote participates.

Referring now to FIG. 5, in use, each client computing device 104 may execute a method 500 for generating an audio output. The method 500 begins with block 502 in which each client computing device 104 identifies the master computing device 102. In some embodiments, the master computing device 102 may be configured to transmit a “hello” packet, which may include identification data of the master computing device 102. In other embodiments, the client computing devices 104 and the master computing device 102 may utilize a hand-shaking procedure to establish the master computing device 102 or the like.

In block 504, the client computing device 104 establishes a session connection with the master computing device 102. To do so, the client computing device 104 may transmit various initial data and information to the master computing device 102 to prepare for the current recording session. For example, in some embodiments, the client computing device may transmit a client ID 232 and a username 236 to the master computing device 102 in block 506. As discussed above, the client ID 232 uniquely identifies the particular client computing device 104 from the other client computing devices 104, and the username is textual identification (e.g., the actual name) of the user of the particular client computing device 104. Additionally, in some embodiments, the client computing device 104 may transmit a voice print 234 of the user of the client computing device 104 to the master computing device 102 in block 508. Further, as discussed in more detail below, each client computing device 104 may be configured to identify a speaker recorded by the local microphone 250. To allow each client computing device 104 to identify any user or other participant, the master computing device 102 may transmit a library of voice prints 234 and associated usernames 236 to each client computing device 104, which is received in block 510.

In block 512, the client computing device 104 establishes a shared master clock with the master computing device 102. To do so, in some embodiments, the master computing device 102 is configured to transmit or broadcast a beacon time stamped with the master clock 152 to each client computing device 104. In such embodiments, the client computing device 104 receives the time-stamped beacon in block 514 and determines a local time offset based on the time-stamped beacon and the local clock 252 of the client computing device 104. For example, the client computing device 104 may determine a time offset by comparing the time stamp of the beacon received from the master computing device 102 and the current time generated by the local clock 252. Such time offset may account for differences in the master clock 152 and the local clock 252, processing and communication delays, and other temporal factors. Alternatively, in other embodiments, the client computing device 104 may be configured to transmit a beacon time stamped with the local clock 252 to the master computing device 102 in block 516. In such embodiments, the master computing device 102 determines a time offset for each client computing device 104 and stores such time offset for use in synchronizing the received audio data packets as discussed in more detail below with regard to FIGS. 6 and 7. Of course, it should be appreciated that other methodologies may be used by the client computing devices 104 and the master computing device 102 to establish the shared master clock in other embodiments.

After the shared master clock has been established in block 512, the method 500 advances to block 518 in which each client computing device 104 determines whether to begin the recording session. In some embodiments, the master computing device 102 may transmit a “start-of-session” signal to each client computing device 104 indicating that recording should begin. In other embodiments, each client computing device 104 may initiate recording upon detecting any audio signals above a reference low level threshold or other criteria.

If client computing device 104 determines that recording should begin, the client computing device begins recording audio signals received by the local microphone 150 in block 520. As discussed above, each client computing device 104 may be configured to identify a speaker of any audio signals received by the local microphone 150. In such embodiments, the client computing device 105 may identify the speaker or speakers in block 522 using the voice prints 234 and username 236. In some embodiments, the client computing device 104 is configured to identify only the user of the client computing device 104 using a voice print 234 of the user. Alternatively, in embodiments in which the client computing device 104 receives a voice print library from the master computing device 102 in block 510, the client computing device 104 may be configured to identify any of the participates using the voice print library and associated usernames. As discussed above, the client computing device 104 may identify a speaker by comparing the recorded audio signal to the voice print 234 or library of voice prints 234.

In block 524, the client computing device 104 packetizes the audio information and time stamps the packet using the shared master clock. For example, in embodiments in which the client computing device 104 receives a master clock 152 time-stamped beacon from the master computing device 102 in block 514, the client computing device 104 may time-stamp each packet using the local clock 252 plus the time-stamp offset determined in block 512. In this way, each client computing device time stamps each generated audio data using a shared master clock that is based on the master clock 152 of the master computing device. Alternatively, in embodiments in which each client computing device 104 transmits a local clock 252 time-stamped beacon to the master computing device 102 in block 516, the client computing device 104 may time-stamp each packet using the local clock 252. Additionally, in embodiments in which the client computing device 104 is configured to identify a speaker recorded in the audio signals generated by the local microphone 150, the client computing device 104 may incorporate or otherwise associate the username of the identified speaker with the audio data packet in block 524.

Subsequently, in block 526, the client computing device 104 determines whether the recording session is completed. In some embodiments, the master computing device 102 may transmit an “end-of-session” signal to indicate the end of the recording session. Alternatively, in other embodiments, the client computing device 104 may infer an end of session if no audio signals are detected within a reference time period. If the recording session is not completed, the method 500 loops back to block 520 in which additional audio signals are recorded.

Referring now to FIGS. 6 and 7, in use, the master computing device 102 may execute a method 600 for generating a final audio output. The method 600 begins with block 602 in which the master computing device 102 is identified by the client computing devices 104. As discussed above, in some embodiments, the master computing device 102 may transmit or broadcast a “hello” packet to each client computing device 104. The “hello” packet may include identification data of the master computing device 102. In other embodiments, the master computing device 102 and the client computing devices 104 may utilize a hand-shaking procedure to establish the master computing device 102 or the like.

In block 604, the master computing device 102 establishes a session connection with each of the client computing devices 104. To do so, the master computing device 102 may request, or otherwise receive, various initial data and information from each client computing device to prepare for the current recording session. For example, in some embodiments, the master computing device 102 may receive a client ID 232 and a username 236 from each client computing device 104 in block 606. Additionally, in some embodiments, the master computing device 102 may receive one or more voice prints 234 of users from each client computing device 104 in block 608. As discussed in more detail below, the master computing device 102 may utilize the client ID 232, the username 236, and, in some embodiments, the voice print 234 to identify a speaker recorded in the audio signals of each received audio data. Additionally or alternatively, each client computing device 104 may be configured to identify a speaker of the recorded audio. In such embodiments, the master computing device 102 may be configured to collect the voice prints 234 and associated usernames 236 received from each of the client computing devices 104 and transmit a library of the voice prints 234 and associated usernames 236 to each client computing device 104 in block 610 to allow each client computing device 104 to identify each user or participant.

In block 612, the master computing device 102 establishes a shared master clock with each of the client computing device 104. To do so, in some embodiments, the master computing device 102 is configured to transmit or broadcast a beacon time-stamped with the master clock 152 in block 614. In such embodiments, as discussed above, the client computing devices 104 may establish the shared master clock by determining a time offset based on the time-stamped beacon from the master computing device 102 and the local clock 252.

Alternatively, in other embodiments, the master computing device 102 may establish a shared master clock by receiving a beacon from each of the client computing devices that has been time stamped with the respective local clock 252 in block 616. Subsequently, in block 618, the master computing device 102 determine a time offset for each client computing device 104 as a function of the time-stamped beacon received from the respective client computing device 104 and the master clock 152. As discussed above, the time offsets may account for differences in the master clock 152 and the local clock 252, processing and communication delays, and other temporal factors. Regardless, the shared master clock is used by the master computing device 102 to synchronize the audio data packets received from the client computing devices 104 as discussed in more detail below.

After the shared master clock has been established, the master computing device 102 determines whether to begin the recording session in block 620. The master computing device 102 may determine to begin the recording session based on any criteria such as an indication provided by a user of the master computing device 102, the determination that each of the client computing devices 104 is ready for the session, or other factors or criteria. If the master computing device 102 determines that the session should begin, the method 600 advances to block 622 (see FIG. 7) in some embodiments. In block 622, the master computing device 102 may transmit a “start-of-session” signal to each of the client computing devices 104. In response, the client computing devices 104 may begin recording audio signals received by the local microphones 250.

In block 624, the master computing device 102 receives the packetized audio data from each client computing device 104 and generates a final audio output based on the audio data in block 626. To do so, the master computing device 102 may unpacketize the received audio data packets in block 626. Additionally, because some audio data packets may be received at different times and in different orders from any one or more of the client computing devices 104, the master computing device 102 may synchronize the received data packets in block 628 using the shared master clock. For example, in embodiments in which the master computing device 102 transmits the master clock 152 time-stamped beacon, the client computing devices 104 are configured to time-stamp each audio data packet using the shared master clock (i.e., a time stamp generated based on the local clock 252 and the time offset determined in block 514 of method 500 of FIG. 5). In such embodiments, the master computing device 102 may synchronize the audio data packets using the time-stamp of each data packet. Alternatively, in embodiments in which the master computing device 102 receives a local clock 252 time-stamped beacon from each client computing device 104, the master computing device 102 may synchronize the audio data packets using the time offset determined for the corresponding client computing device 104 in block 618. In this way, the master computing device 102 may synchronize and properly analyze the audio data received from each client computing device.

In the illustrative embodiment, the master computing device 102 is configured to generate the final audio data by analyzing the signal-to-noise (SNR) ratio of the audio signals included in each audio data packet received from the client computing devices 104. In this way, the master computing device 102 determines which microphone 250 is best placed to record the current speaker, who may be a user of any one of the client computing device 104 or otherwise nearer one of the client computing device 104 relative to the other client computing devices 104 (e.g., the speaker may be walking about). To do so, in some embodiments, the master computing device 102 may compare the signal-noise ratio of each audio signal received from the client computing devices 104 in block 630 and select the audio signal having the greatest signal-to-noise ratio to include in the final audio output in block 632. In this way, only a single audio signal is selected for use in the final audio output, and the remaining audio signals received in the audio data packets are ignored. Of course; over time, the client computing device 104 producing the audio signal having the greatest signal-to-noise ratio may change over time as different users or participates speak. As such, the master computing device 102 continues to compare the audio signals for each time window and selects the audio signal having the greatest signal-to-noise ratio for use in the final audio output.

In other embodiments, the master computing devices may compare the audio signal included in the audio data received from each client computing device 104 to a reference threshold in block 634. Each audio signal having a signal-to-noise greater than the reference threshold is selected for inclusion in the final audio output in block 636. However, because the audio signals recorded by each client computing device 104 may not be synchronized in time with each other, the master computing device 102 may further process the signals to synchronize the selected audio signals. For example, in some embodiment, the master computing device 102 may time shift one or more of the selected audio signals in block 638. To do so, the master computing device 102 may utilize the shared master clock or other audio signal processing techniques or methodologies.

Additionally, in some embodiments, the master computing device 102 is configured to perform an echo cancellation process on the selected signals to remove echoes or duplicative signals from the selected audio signals. For example, the master computing device 102 may identify a primary audio signal from selected audio signals based on signal-to-noise ratio, or other criteria, and subsequently subtract, or otherwise, remove duplicative signals from the primary audio signals thereby removing or reducing the occurrence of echoes or other duplicative sounds.

As discussed above, in some embodiments, the master computing device 102 may be configured to identify a speaker or speakers of the selected audio signals in block 640. To do so, the master computing device 102 may utilize the speaker identity data 132, which may include the client ID 232 associated with the username 236 and/or the voice print 234 associated with the username 236. For example, in some embodiments, the master computing device 102 may compare the client ID 232 associated with the audio data packets of the selected audio signals to the speaker identity data 132 to determine the username 236 associated with the client ID 232 in block 642. Additionally or alternatively, the master computing device 102 may compare the audio signal to the voice prints 234 received from the client computing devices 104 in block 644. If a match between the selected audio signal and a voice print 234 is found, the master computing device 102 may determine the username 236 associated with the respective voice print 234. Regardless, after a speaker is identified, the master computing device 102 may “tag,” associate, or otherwise incorporate the username with the selected audio signal in block 640. Alternatively, in some embodiments, the username is used for generating a transcript of the final audio output and may not be otherwise associated with the final audio output.

The generated final audio output may be stored on the master computing device 102 and/or transmitted to other devices. For example, in some embodiments, the master computing device 102 is configured to transmit the final audio output to the remote computing device(s) 108 over the external network 110 and/or to the telephonic device 112 in block 646. In this way, the audio provided to such non-local participants may have a higher quality and overall signal-to-noise ratio due to the use of the multiple local microphones 250, relative to the use of a single, centralized microphone.

In block 648, the master computing device 102 determines whether the current session has ended. The master computing device 102 may use any methodology or criteria to determine the end of the current session. For example, the master computing device 102 may determine the end of the current session based on a selection or indication provided by a user of the master computing device 102, based on an amount of elapsed time, or other factor or criteria. If the session is determined to not be completed, the method 600 loops back to 624 in which the master computing device 102 continues to receive packetized audio data from the client computing devices. However, if the master computing device 102 determines that the current session has ended, the method 600 advances to block 650 in which the master computing device 102 may transmit or broadcast an “end-of-session” signal to each of the client computing devices 104.

### EXAMPLES

Illustrative examples of the devices, systems, and methods disclosed herein are provided below. An embodiment of the devices, systems, and methods may include any one or more, and any combination of, the examples described below.

In one example, a master computing device for generating an audio output may include a communication module to receive audio data over a wireless network from a plurality of client computing devices and an audio processing module to select audio data from the received audio data based on a signal-to-noise ratio of an audio signal of each received audio data and generate a final audio output as a function of the selected audio data. The audio data may be recorded by each client computing device using a microphone of the corresponding computing device. In an example, the master computing device may further include a master clock and the communication module is to establish a shared master clock between the master computing device and the plurality of client computing devices by transmitting a beacon that is time stamped using the master clock. In an example, the audio data received from each of the client computing devices is time stamped using the shared master clock and the audio processing module to select audio data from the received audio data having similar time stamps.

Additionally, in an example, the master computing device may further include a master clock, the communication module is to receive, from each of the client computing devices, a beacon time stamped with a local clock of the client computing device, and the audio processing module is to establish a shared master clock by determining an offset for each of the client computing devices as a function of the master clock and the beacon received from each of the client computing devices. In an example, the audio processing module is to generate the final audio output by shifting the audio signal of the selected audio data as a function of the shared master clock.

In an example, the audio processing module is to compare the signal-to-noise ratio of the audio signal of each received audio data, select the audio data having the greatest signal-to-noise ratio, and generate the final audio output using only the selected audio data. In an example, the audio processing module is to compare the signal-to-noise ratio of the audio signal of each received audio data to a reference threshold, select each audio data having a signal-to-noise ratio greater than the reference threshold, and generate the final audio output using only the selected audio data. In an example, the audio processing module is to shift a phase of the audio signal of at least one of the audio data such that the audio signals of the selected audio data are in phase with each other.

In an example, the communication module is to transmit the final audio output to a remote computing device. In an example, the communication module is to receive identification data from each of the client computing devices that identifies the corresponding client computing device, and the audio processing module is to generate the final audio output as a function of the selected audio data and the identification data. In an example, the communication module is to receive, from each of the client computing devices, a voice print and username of a user of the corresponding client computing device, and the audio processing module is to identify a speaker of the audio signal of the selected audio data based on the voice print and generate the final audio output as a function of the selected audio data and the identity of the speaker. In an example, the communication module is to transmit each of the received voice prints and associated usernames to each of the client computing devices.

In another example, a client computing device for transmitting audio to a master computing device to generate an audio output may include a microphone to generate an audio signal, a local clock, a communication module to receive a master clock signal from the master computing device, and an audio processing module to (i) determine a shared master clock based on an output of the local clock and the master clock and (ii) generate audio data as a function of the audio signal, the audio data being time stamped using the shared master clock. In an example, the communication module is to packetize the audio data and transmit the packetized audio data to the master computing device. In an example, the client computing device may further include a voice print database having stored therein a voice print of a user of the client computing device and a username of the user and the communication module is to transmit the voice print and username to the master computing device.

In an example, the client computing device may include a library of voice prints and associated usernames and the audio processing module is to identify a speaker as a function of the audio signal, the voice prints, and the associated usernames. In an example, the packetized audio data includes the username of the identified speaker.

In another example, a system for generating an audio output may include a master computing device and a plurality of client computing devices. In an example, each client computing device is to record audio signals using a microphone of the corresponding client computing, generate audio data based on the audio signals, and transmit the audio data to the master computing device over a wireless network. In an example, the master computing device is to receive the audio data from each of the plurality of client computing devices and generate a final audio output as a function of the audio data received from the client computing devices. In an example, the master computing device and the plurality of client computing devices are to establish an ad hoc wireless network and each of the client computing devices is to transmit the audio data to the master computing device over the ad hoc wireless network. In an example, the master computing device and the plurality of client computing devices are to establish a shared master clock. Each of the client computing devices is to time stamp the audio data using the shared master clock prior to transmitting the audio data to the master computing device. In an example, the master computing device is to transmit a beacon time stamped using a master clock of the master computing device to each of the client computing devices, each of the client computing devices comprises a local clock, and each client computing device is to determine the shared master clock based on an output of the local clock and the master clock.

In an example, each of the client computing devices may include a local clock and is to transmit a beacon time stamped using the local clock to the master computing device. In an example, the master computing device is to determine an offset for each of the client computing devices as a function of a master clock of the master computing device and beacon received from each client computing device. In an example, the master computing device is configured to (i) compare the signal-to-noise ratio of the audio signal of each received audio data, (ii) select the audio data having the greatest signal-to-noise ratio, and (iii) generate the final audio output using only the selected audio data. In an example, the master computing device is configured to (i) compare the signal-to-noise ratio of the audio signal of each received audio data to a reference threshold, (ii) select each audio data having a signal-to-noise ratio greater than the reference threshold, and (iii) generate the final audio output using only the selected audio data. Additionally, in an example, each client computing device is to transmit, in association with the audio data, identification data that identifies the corresponding client computing device, and the master computing device is to generate the final audio output as a function of the audio data and identification data received from the client computing devices. In an example, each client computing devices includes a voice print database having stored therein a voice print of a user of the corresponding client computing device and a username of the user and each client computing device is to transmit the voice print and username to the master computing device. In an example, the master computing device is to receive the voice print and username from each client computing device and identify a speaker of the audio signal of the received audio data based on the voice print and generate the final audio output as a function of the audio data and the identity of the speaker:

In another example, a method for generating an audio output on a master computing device may include receiving, on the master computing device, audio data over a wireless network from a plurality of client computing devices. The audio data may be recorded by each client computing device using a microphone of the corresponding computing device. the method may also include selecting, on the master computing device, audio data from the received audio data based on a signal-to-noise ratio of an audio signal of each received audio data and generating a final audio output as a function of the selected audio data. In an example, the method further include establishing a shared master clock between the master computing device and the plurality of client computing devices by transmitting, from the master computing device, a beacon that is time stamped using a master clock of the master computing. In an example, receiving audio data from the plurality of client computing devices comprises receiving audio data that is time stamped using the shared master clock from each of the plurality of client computing devices and selecting audio data comprises selecting audio data from the received audio data having similar time stamps.

In an example, the method may further include receiving, on the master computing device and from each client computing device, a beacon time stamped with a local clock of the corresponding client computing device and establishing a shared master clock by determining an offset for each of the client computing devices as a function of a master clock of the master computing device and the beacon received from each of the client computing devices. In an example, generating the final audio output may include shifting the audio signal of the selected audio data as a function of the shared master clock. In an example, selecting the audio data comprises comparing the signal-to-noise ratio of the audio signal of each received audio data and selecting the audio data having the greatest signal-to-noise ratio and generating the final audio output comprises generating a final audio output using only the selected audio data. In an example, selecting the audio data comprises comparing the signal-to-noise ratio of the audio signal of each received audio data to a reference threshold and selecting each audio data having a signal-to-noise ratio greater than the reference threshold, and generating the final audio output comprises generating a final audio output using only the selected audio data. In an example, the method may further include shifting a phase of the audio signal of at least one of the audio data such that the audio signals of the selected audio data are in phase with each other.

In an example, the method may further include transmitting the final audio output to a remote computing device. In an example, the method may further include receiving identification data from each of the client computing devices that identifies the corresponding client computing device. In an example, generating the final audio output comprises generating a final audio output as a function of the selected audio data and the identification data. In an example, the method may further include receiving, from each of the client computing devices, a voice print and username of a user of the corresponding client computing device and identifying, on the master computing device, a speaker of the audio signal of the selected audio data based on the voice print. In an example, generating the final audio output comprises generating a final audio output as a function of the selected audio data and the identity of the speaker. In an example, the method may further include transmitting each of the received voice prints and associated usernames to each of the client computing devices.

In to another example, a method for transmitting audio from a client computing device to a master computing device to generate an audio output may include generating an audio signal using a microphone of the client computing device, receiving a master clock signal from the master computing device, determining a shared master clock based on an output of a local clock of the client computing device and the master clock, generating audio data as a function of the audio signal, time stamping the audio data using the master clock, packetizing the time stamped audio data, and transmitting the packetized, time stamped audio data to the master computing device. In an example, the method may further include transmitting a voice print of a user of the client computing device and username of the user from the client computing device to the master client computing device. In an example, the method may include identifying a speaker as a function of the audio signal and a voiceprint stored on the client computing device.

In another example, a method for recording audio information may include establishing a wireless network between a mater computing device and a plurality of client computing devices, recording audio data on each of the client computing devices using a microphone of the corresponding client computing device, transmitting the audio data from each of the client computing devices to the master computing device over the wireless network, and generating a final audio output on the master computing device as a function of the audio data received from each of the client computing devices. In an example, establishing a wireless network comprises establishing an ad hoc wireless network between the master computing device and the plurality of client computing devices. In an example, the method may further include transmitting, from each of the client computing devices to the master computing device, identification data that identifies the corresponding client computing device. In an example, the method may further include transmitting, from each of the client computing devices to the master computing device, a username associated with a user of the corresponding client computing device, wherein the username is associated with the identification data.

In an example, the method may further include transmitting, from each of the client computing devices to the master computing device, a voice print of a user of the corresponding client computing device and a username that identifies the user of the corresponding computing device. In an example, the method may further include identifying, on the master computing device, a speaker captured in an audio signal of at least one of the audio data received from the client computing devices using the voiceprints and usernames received from the client computing devices. In an example, the method may further include transmitting, from the master computing device to each of the client computing devices, the voice prints of the users and associated usernames to establish a library of voice prints and associated usernames in each of the client computing devices. In an example, the method may further include identifying, on one of the client computing devices, a speaker captured using the microphone of the corresponding client computing device using the library of voice prints. In an example, the method may further include establishing a master clock between the master computing device and each of the client computing devices. In an example, establishing the master clock comprises transmitting, from the master computing device to each of the client computing devices, a beacon that is time stamped using a master clock of the master computing device.

In an example, transmitting the audio data from each of the client computing devices to the master computing device comprises determining a time offset for each of the client computing devices based on the master clock time stamp and a local clock of the corresponding client computing device, generating a time stamped audio data packet, on each of the client computing device, as a function of the corresponding time offset, and transmitting the time stamped audio data packet from each of the client computing devices to the master computing device. In an example, establishing the master clock comprises receiving, on the master computing device from each of the client computing devices, a beacon time stamped with a local clock of the corresponding client computing device and determining, on the master computing device, a time offset for each of the client computing device as a function of the corresponding local clock time stamp and a master clock of the master computing device. In an example, generating the final audio output comprises shifting a phase of an audio signal of at least one of the audio data received from the client computing devices as a function of the corresponding time offset.

In an example, generating the final audio output comprises comparing, on the master computing device, a signal-to-noise ratio of the audio data received from each of the client computing devices, selecting the audio data having the greatest signal-to-noise ratio, and generating the final audio output using only the selected audio data. In an example, generating the final audio output comprises comparing, on the master computing device, a signal-to-noise ratio of the audio data received from each of the client computing devices to a reference threshold, selecting each audio data having a signal-to-noise ratio greater than the reference threshold, and generating the final audio output using only the selected audio data. In an example, generating the final audio output using only the selected audio data may include shifting an audio signal of at least one of the audio data such that the audio signal is in phase with each audio signal of the other audio data. In an example, the method may further include transmitting the final audio output to a remote computing device.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected. For example, it should be appreciated that the term “mobile computing device” as used herein can refer to computing devices that can be carried by a person as well as computing devices that are otherwise mobile.

1-61. (canceled)

62. A master computing device for generating an audio output, the master computing device comprising:
a communication module to receive audio data over a wireless network from a plurality of client computing devices, the audio data recorded by each client computing device using a microphone of the corresponding computing device; and
an audio processing module to select audio data from the received audio data based on a signal-to-noise ratio of an audio signal of each received audio data and generate a final audio output as a function of the selected audio data.

63. The master computing device of claim 62, further comprising a master clock,
wherein the communication module to establish a shared master clock between the master computing device and the plurality of client computing devices by transmitting a beacon that is time stamped using the master clock.

64. The master computing device of claim 62, further comprising a master clock, wherein:
the communication module to receive, from each of the client computing devices, a beacon time stamped with a local clock of the client computing device;
the audio processing module to establish a shared master clock by determining an offset for each of the client computing devices as a function of the master clock and the beacon received from each of the client computing devices.

65. The master computing device of claim 62, wherein the audio processing module to:
compare the signal-to-noise ratio of the audio signal of each received audio data;
select the audio data having the greatest signal-to-noise ratio; and
generate the final audio output using only the selected audio data.

66. The master computing device of claim 62, wherein the audio processing module to:
compare the signal-to-noise ratio of the audio signal of each received audio data to a reference threshold;
select each audio data having a signal-to-noise ratio greater than the reference threshold; and
generate the final audio output using only the selected audio data.

67. The master computing device of claim 62, wherein:
the communication module to receive, from each of the client computing devices, a voice print and username of a user of the corresponding client computing device; and
the audio processing module to identify a speaker of the audio signal of the selected audio data based on the voice print and generate the final audio output as a function of the selected audio data and the identity of the speaker.

68. A client computing device for transmitting audio to a master computing device to generate an audio output, the client computing device comprising:
a microphone to generate an audio signal;
a local clock;
a communication module to receive a master clock signal from the master computing device; and
an audio processing module to (i) determine a shared master clock based on an output of the local clock and the master clock and (ii) generate audio data as a function of the audio signal, the audio data being time stamped using the shared master clock,
wherein the communication module to packetize the audio data and transmit the packetized audio data to the master computing device.

69. The client computing device of claim 68, further comprising a voice print database having stored therein a voice print of a user of the client computing device and a username of the user,
wherein the communication module is to transmit the voice print and username to the master computing device.

70. The client computing device of claim 68, further comprising a library of voice prints and associated usernames,
wherein the audio processing module is to identify a speaker as a function of the audio signal, the voice prints, and the associated usernames.

71. One or more computer readable storage media comprising a plurality of instructions stored thereon that, in response to being executed, cause a master computing device to:
receive audio data over a wireless network from a plurality of client computing devices, the audio data being recorded by each client computing device with a microphone of the corresponding computing device;
select audio data from the received audio data based on a signal-to-noise ratio of an audio signal of each received audio data; and
generate a final audio output as a function of the selected audio data.

72. The one or more computer readable storage media of claim 71, wherein the plurality of instructions, in response to being executed, cause the master computing device to transmit a beacon that is time stamped with a master clock of the master computing device to establish a shared master clock between the master computing device and the plurality of client computing devices.

73. The one or more computer readable storage media of claim 71, wherein the plurality of instructions, in response to being executed, cause the master computing device to:
receive, from each client computing device, a beacon time stamped with a local clock of the corresponding client computing device, and
determine an offset for each of the client computing devices as a function of a master clock of the master computing device and the beacon received from each of the client computing devices to establish a shared master clock.

74. The one or more computer readable storage media of claim 71, wherein to:
select the audio data comprises to compare the signal-to-noise ratio of the audio signal of each received audio data and to select the audio data having the greatest signal-to-noise ratio, and
generate the final audio output comprises to generate a final audio output based only on the selected audio data.

75. The one or more computer readable storage media of claim 71, wherein to:
select the audio data comprises to compare the signal-to-noise ratio of the audio signal of each received audio data to a reference threshold and to select each audio data having a signal-to-noise ratio greater than the reference threshold, and
generate the final audio output comprises to generate a final audio output based only on the selected audio data.

76. The one or more computer readable storage media of claim 71, wherein the plurality of instructions, in response to being executed, cause the master computing device to:
receive, from each of the client computing devices, a voice print and username of a user of the corresponding client computing device;
identify, on the master computing device, a speaker of the audio signal of the selected audio data based on the voice print, and
wherein to generate the final audio output comprises to generate a final audio output as a function of the selected audio data and the identity of the speaker.

77. One or more computer readable storage media comprising a plurality of instructions stored thereon that, in response to being executed, cause a client computing device to:
generate an audio signal using a microphone of the client computing device;
receive a master clock signal from the master computing device;
determine a shared master clock based on an output of a local clock of the client computing device and the master clock;
generate audio data as a function of the audio signal;
time stamp the audio data using the master clock;
packetize the time stamped audio data; and
transmit the packetized, time stamped audio data to the master computing device.

78. The one or more computer readable storage media of claim 77, wherein the plurality of instructions, in response to being executed, cause the client computing device to transmit a voice print of a user of the client computing device and username of the user from the client computing device to the master client computing device.

79. The one or more computer readable storage media of claim 77, wherein the plurality of instructions, in response to being executed, cause the client computing device to identify a speaker as a function of the audio signal and a voiceprint stored on the client computing device.
